(19) United States
(12) Patent Application Publication
(10) Pub. No.: US 2025/0082976 A1
(43) Pub. Date: Mar. 13, 2025

(54) Fire-fighting nozzle and sensor carrier

(71) Applicant: Peter Kammer, Feldbrunnen (CH)

(72) Inventor: Peter Kammer, Feldbrunnen (CH)

(21) Appl. No.: 18/826,291

(22) Filed: Sep. 6, 2024

(30) Foreign Application Priority Data
Sep. 8, 2023 (EP) EP23196320

(51) Int. Cl. A62C 37/08; A62C 37/36

(52) U.S. Cl. CPC A62C 37/08; A62C 37/04

(57) ABSTRACT

The invention relates to a firefighting nozzle comprising a nozzle body (1) with a channel (11) that is suitable for the flow of extinguishing agent, and a closure (2) that is suitable for tightly closing the channel (11) to prevent the passage of extinguishing agent. The fire-fighting nozzle is characterized by a mechanical nozzle connection (31) for detachably anchoring a sensor carrier (4) to the nozzle body (1). The invention also relates to a sensor carrier (4) comprising a support body (41) which is provided with at least one sensor (42), with a signal transmitter (44) and with a mechanical support connection (43) for anchoring the support body (41) to a fire-fighting nozzle, wherein the sensor (42) is connected to the signal transmitter (44).

### BACKGROUND OF THE INVENTION

The present invention relates to a fire-fighting nozzle with nozzle connection means for connecting a sensor carrier according to claim 1, a sensor carrier with carrier connection means for mounting on a fire-fighting nozzle according to claim 11 and a fire-fighting system according to claim 14.

Fire-fighting nozzles are devices that are arranged on the ceilings and/or walls of a building and are triggered in the event of a fire. Extinguishing agent is then distributed from a pipe system over a certain building area in order to extinguish the fire or to prevent or at least slow down its spread. Sensors such as fire, temperature and smoke sensors etc., which are distributed throughout the building, are used to detect a fire and to trigger the fire-fighting nozzles at an early stage.

In the same building area that is to be monitored and protected against fires, fire-fighting nozzles and/or sprinklers as well as sensors are therefore arranged. All of these elements must be attached to the ceiling or walls of the building. The installation of a fire-fighting system is complex if all the associated elements have to be mounted individually and at different locations in the building area to be protected. This also makes inspection and maintenance work more complex if each element has to be checked individually and replaced if necessary.

### SUMMARY OF THE INVENTION

The object of the present invention is to provide a solution that simplifies the installation, inspection and maintenance of a fire-fighting system with fire-fighting nozzles and sensors.

This object is achieved by the fire-fighting nozzle with nozzle connection means for connecting or receiving a sensor carrier according to claim 1, by the sensor carrier with carrier connection means for mounting on a fire-fighting nozzle according to claim 11 and by the fire-fighting system according to claim 14. Further features and embodiments are claimed in the dependent claims and their advantages are explained in the following description.

The core of the invention is a fire-fighting nozzle with connection means for sensors, so that a fire-fighting nozzle with dual function (detection & fighting the fire) can be used in the area to be protected, and the fire sensors do not have to be mounted separately and in addition to the fire-fighting nozzle at other places on the ceiling or walls of the area to be protected. The sensors mounted on the fire-fighting nozzle can be connected to a control system or a building management system. To make it easy to replace the sensors, they are arranged on a removable sensor carrier that is detachably attached to the fire-fighting nozzle.

### BRIEF DESCRIPTION OF DRAWINGS

FIG. 1a-b Side views of a cross-section of variants of fire-fighting nozzle with mounted sensor carrier

FIG. 2 Top view of the fire-fighting nozzle with various sensors

The figures show possible embodiments of the invention, which are explained in the following description.

### DETAILED DESCRIPTION OF THE INVENTION

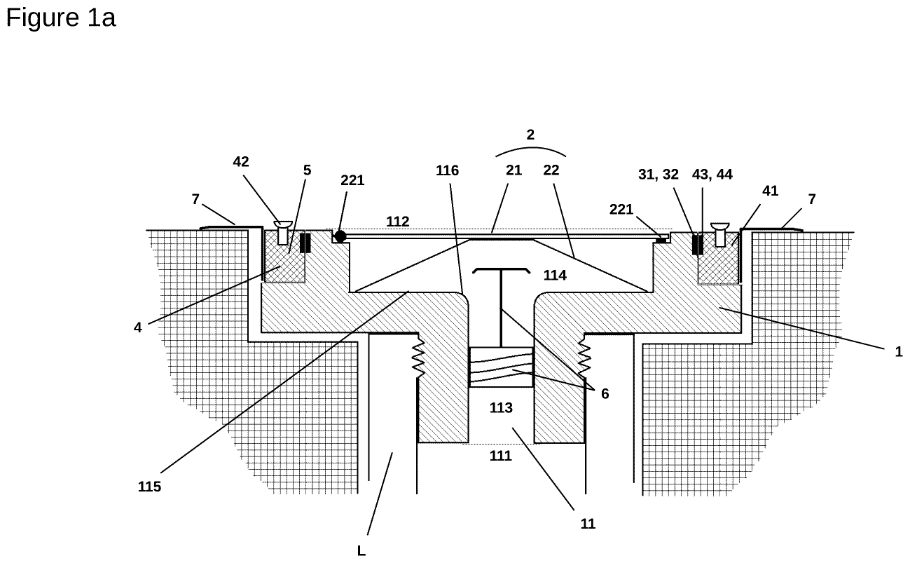

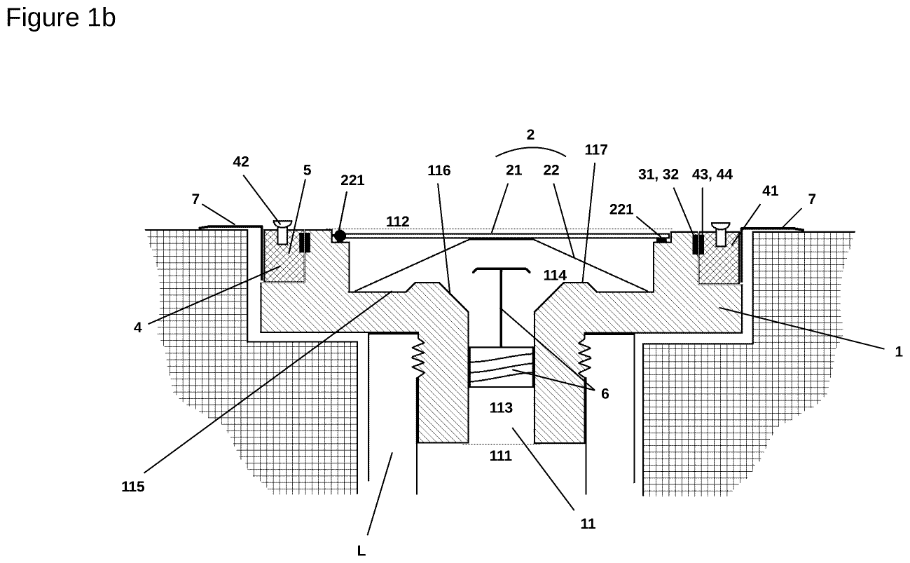

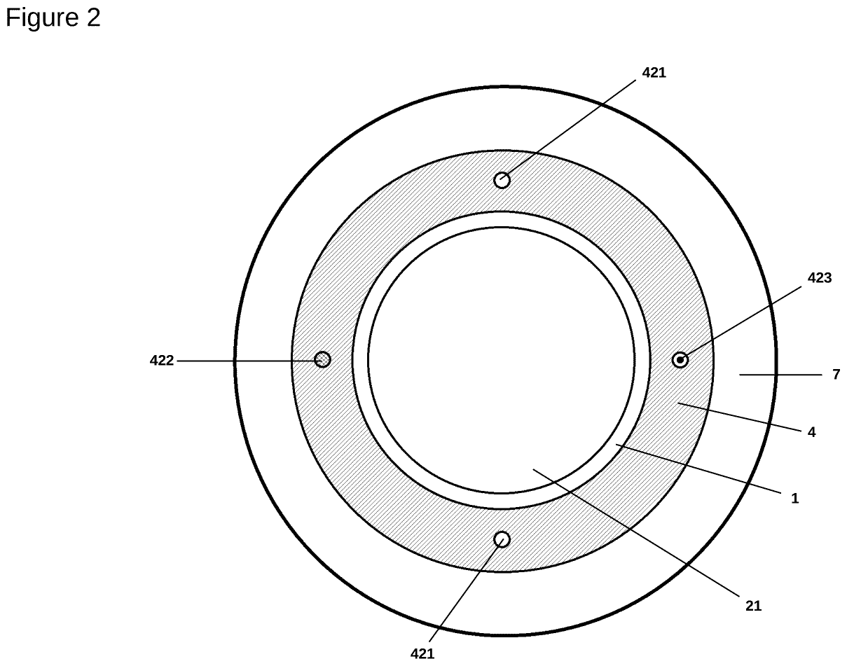

The fire-fighting nozzle according to the invention comprises a nozzle body 1 with a channel 11, through which the extinguishing agent flows, when in use, from an inlet end 111 to an outlet end 112, and also comprises a closure 2, which tightly closes the channel 11 against the passage of extinguishing agent. According to the invention, the nozzle body is provided with at least one mechanical nozzle connection 31 for anchoring a sensor carrier 4 to the nozzle body 1 (see FIGS. 1a, 1b and 2).

The sensor carrier 4 according to the invention comprises a support body 41, which is provided with at least one sensor 42, at least one signal transmitter 44 and at least one mechanical support connection 43 for anchoring the support body 41 to a fire-fighting nozzle. The sensor 42 is preferably suitable for fire detection and is, for example, a temperature, fire or smoke sensor 421. The advantages of the invention also arise when other types of sensors 42 are used which are not necessarily used for fire detection. For example, burglar alarms 422, cameras 423 for video surveillance or any other devices used in building management for status checking and monitoring can be arranged on the fire-fighting nozzle as sensors 42. The sensor 42 is connected to the signal transmitter 44 so that the information detected by the sensor can be passed on to the signal transmitter 44. When the sensor carrier 4 is mounted on the fire-fighting nozzle, the mechanical nozzle connection 31 is coupled to the mechanical carrier connection 43, thereby firmly anchoring the sensor carrier 4 to the nozzle body 1.

The signal transmitter 44 is used to transmit a signal from the sensor 42 to the fire-fighting nozzle or to the environment, in particular for fire control. The signal transmitter 44 is, for example, an acoustic device which emits an acoustic signal when the sensor 42 detects a fire or a break-in. The signal transmitter 44 can also be an electronic device for emitting an electromagnetic signal, for example a Bluetooth device, a WiFi device or similar. This electromagnetic signal is received by the fire-fighting nozzle provided with a corresponding signal receiver. In the preferred embodiment of the invention, the signal transmitter 44 is an electrical carrier connection 44 for establishing an electrical connection between the signal transmitter 44 and the fire-fighting nozzle. In this case, the nozzle body 1 of the fire-fighting nozzle is provided with an electrical nozzle connection 32. When the sensor carrier 4 is mounted on the fire-fighting nozzle, the electrical carrier connection 44 is coupled to the electrical nozzle connection 32 so that the information detected by the sensor 42 can be transmitted to the fire-fighting nozzle. It is also advantageous if the electrical nozzle and carrier connections 32, 44 are used in addition or instead to transmitting information from the sensor carrier 4 to the fire-fighting nozzle, to also supply power to the sensor carrier 4. In addition or instead, the sensor carrier 4 can be provided with a battery.

The sensor carrier 4 could, for its power supply, be connected to the fire-fighting nozzle through the electrical nozzle and carrier connections 32, 44 and additionally be provided with a backup battery in case of power failure.

The mechanical connection between the sensor carrier 4 and the nozzle body 1 must be detachable to enable the sensor carrier 4 to be replaced and can be made in various ways. Hereunder a few examples of possible connections:
a connection with screw threads, in which case the mechanical nozzle connection 31 is an external thread and the mechanical carrier connection 43 is an internal thread, or vice versa;
a connection with a bayonet mount, in which case the mechanical nozzle connection 31 is a groove and the mechanical carrier connection 43 is a pin protruding into it, or vice versa;
a connection with a magnet, if the mechanical nozzle connection 31 or the mechanical carrier connection 43 is a magnet and the carrier body 41 or the nozzle body 1 has ferromagnetic material. Alternatively, the mechanical nozzle connection 31 and the mechanical support connection 43 may be magnets of opposed polarity.
a connection by plugging a male element into a female element as in conventional electrical sockets or in a door latch, in which case the mechanical nozzle connection 31 is a female element and the mechanical support connection 43 is a male element mating therewith, or vice versa.

The connection between the electrical carrier connection 44 and the electrical nozzle connection 32 must also be detachable in order to enable the sensor carrier 4 to be replaced, and is carried out using known measures. It is particularly advantageous if the mechanical connection between the sensor carrier 4 and the nozzle body 1 also simultaneously establishes the electrical connection between them. This ensures quick and easy attachment and removal of the sensor carrier 4 on the fire-fighting nozzle. For example, the following connections are possible:
a connection with screw threads, in which case the mechanical nozzle connection 31 is an external thread and the mechanical carrier connection 43 is an internal thread, or vice versa. In this case, the electrical connection can be made, for example, in a similar way to conventional light bulbs with a screw cap, as soon as the sensor carrier 4 is screwed onto the nozzle body 1: the external and internal threads can be made of electrically conductive material and form the first electrical contact, and the second electrical contact is made by contact between electrically conductive materials at another location.
a connection with a bayonet mount, in which case the mechanical nozzle connection 31 is a groove and the mechanical carrier connection 43 is a pin protruding into it, or vice versa. The electrical connection can in this case be made as with conventional light bulbs with a bayonet mount as soon as the sensor carrier 4 is attached to the nozzle body 1.
a connection with a magnet, if the mechanical nozzle connection 31 or the mechanical carrier connection 43 is a magnet and the carrier body 41 or the nozzle body 1 has ferromagnetic material. Alternatively, the mechanical nozzle connection 31 and the mechanical carrier connection 43 can also be magnets of opposite polarity. The electrical connection can in this case be made by contact between electrically conductive areas on the nozzle body 1 and the sensor carrier 4 that are pressed against each other by the magnets.
a connection by plugging a conductive male element in a conductive female element as with conventional electrical sockets.

It is advantageous if the mechanical nozzle connection 31 and the electrical nozzle connection 32 are located in a visible area of the nozzle body 1 that is accessible from the outside when the fire-fighting nozzle is mounted on a wall or ceiling. A suitable location for the mechanical nozzle connection 31 and the electrical nozzle connection 32 is on the front side of the nozzle body, on which the outlet end 112 of the channel 11 is located, but outside of the channel 11. The sensor carrier 4 can thus be replaced without having to open or remove the nozzle. It is particularly advantageous if a recess 5 is provided on this front side of the nozzle body 1, which is adapted to the geometry of the sensor carrier 4 in such a way that the mounted sensor carrier 4 does not protrude from the front side of the nozzle body 1. This ensures a particularly compact design of the fire-fighting nozzle.

In the preferred embodiment of the invention, the sensor carrier is ring-shaped and is arranged around the outlet end 112 of the channel 11 in a corresponding ring-shaped recess 5.

The sensor carrier 4 preferably comprises all sensitive electronic components that could need to be replaced, i.e. not only the sensors 42, but also any other electronic components that are necessary for the operation of the sensors 42. By replacing the sensor carrier, all sensitive elements can thus be replaced at the same time. The sensor carrier 4 preferably comprises the sensors 42 arranged on it, all sensitive electronic components that need to be replaced and the carrier connection 43, but no other components, in order to keep it as simple in construction and as cost-effective as possible.

Preferably, the nozzle body 1 has, in the region of the inlet end 111 of the channel 11, means for fastening the nozzle body 1 to an extinguishing agent supply L of a pipeline system, for example an external or internal thread. It is particularly advantageous if the channel 11 has two regions with different diameters: a narrower region 113 on the side of the inlet end 111 and a wider region 114 on the side of the outlet end 112. The narrower region 113 of the channel 11 can be provided with means 6 for shaping the extinguishing agent jet that flows out of the fire-fighting nozzle in the event of use. These means are, for example, a nebulizer for generating water mist, a distribution plate for distributing the extinguishing agent jet over a larger area or other constructive measures for swirling the extinguishing agent jet and obtaining an ideal droplet size and the desired spray pattern, with a specific, e.g. spiral-shaped, nozzle insert or with spiral-shaped grooves on the inner wall of the narrower area 113 of the channel 11. The wider area 114 of the channel 11 is preferably used to accommodate the closure 2, which is completely or partially accommodated therein. In the preferred embodiment of the invention, the closure 2 is completely accommodated in the channel 11 and does not protrude from the nozzle body 1, which ensures a particularly compact design of the fire-fighting nozzle.

The closure 2 preferably comprises a lid 21 and a seal 22 which is held by the lid 21 against the pressure force of the pressurized extinguishing agent. It is advantageous if the lid 21 contains a trigger element which reacts autonomously to fire heat and detaches the lid 21 from the nozzle body 1 in the event of a fire. Alternatively, the lid 21 could be attached to the wider area 113 of the channel 11 at at least two attachment points 211, with at least one attachment point 221 being detachable in the event of a fire. This allows the lid 21 and the seal 22 to be ejected from the channel 11 under the pressure of the extinguishing agent and the fire-fighting nozzle is put into operation. The seal 22 is preferably clamped between the lid 21 and the shoulder 115 of the channel 11, which is located at the interface between the narrower area 113 and the wider area 114. The nozzle edge 116 between the shoulder 115 and the narrower area 113 is preferably designed so that the emerging extinguishing agent has the desired consistency (droplet size) and the correct spray cone and spray angle (spray pattern). The nozzle edge 116 can, for example, have a rounded or slanted shape and the shoulder 115 can be provided with structural means 117 for swirling the extinguishing agent jet and obtaining an ideal droplet size and the desired spray pattern.

For better aesthetics of the fire-fighting nozzle, the circumference of the nozzle body 1 can be provided with a cover rosette 7, which bridges and covers the distance between the nozzle body and the wall or ceiling on which the fire-fighting nozzle is arranged.

The fire-fighting nozzle according to the invention can be used in a fire-fighting system comprising a control system. It is advantageous, for example, if this control system only activates the fire extinguishing by the fire-fighting nozzle when two or more sensors 42, in particular adjacent sensors 42, report a fire and/or manual activation is carried out by the fire brigade.

1. Firefighting nozzle comprising a nozzle body (1) with a channel (11) suitable for the flow of extinguishing agent and a closure (2) suitable for tightly closing the channel (11) against the passage of extinguishing agent, characterized by a mechanical nozzle connection (31) for detachably anchoring a sensor carrier (4) on the nozzle body (1).

2. Firefighting nozzle according to claim 1, characterized by a sensor carrier (4) comprising a support body (41) provided with at least one sensor (42), a signal transmitter (44) and a mechanical support connection (43) for anchoring the support body (41) to the firefighting nozzle, wherein the sensor (42) is connected to the signal transmitter (44), wherein the mechanical nozzle connection (31) is detachably coupled to the mechanical support connection (44) so that the sensor carrier (4) is detachably mounted on the nozzle body (1).

3. Firefighting nozzle according to claim 2, characterized by an electrical nozzle connection (32) for establishing a detachable electrical connection between the nozzle body (1) and the sensor carrier (4).

4. Firefighting nozzle according to claim 3, characterized in that the channel (11) has an inlet end (111) for extinguishing agent on the rear side of the nozzle body (1) and an outlet end (112) for the extinguishing agent on the front side of the nozzle body (1), wherein the mechanical nozzle connection (31) and the electrical nozzle connection (32) are arranged on the front side of the nozzle body (1) and outside of the channel (11).

5. Firefighting nozzle according to claim 4, characterized in that on the front side of the nozzle body (1) a recess (12) is provided in which the mechanical nozzle connection (31) and the electrical nozzle connection (32) are located.

6. Firefighting nozzle according to claim 3, characterized in that the signal transmitter (44) is an electrical carrier connection (44) which is detachably coupled to the electrical nozzle connection (32) so that the sensor (42) is electrically connected to the electrical nozzle connection (32).

7. Firefighting nozzle according to claim 6, characterized in that the coupling of the electrical nozzle connection (32) to the electrical carrier connection (44) is established simultaneously with the coupling of the mechanical nozzle connection (32) to the mechanical carrier connection (43).

8. Firefighting nozzle according to claim 5, characterized in that the sensor carrier (4) is arranged in the recess (12) and the recess (12) is adapted to the geometry of the sensor carrier (4) such that the sensor carrier (4) does not protrude from the front side of the nozzle body (1).

9. Firefighting nozzle according to claim 8, characterized in that the recess (12) is designed in a ring shape around the outlet end (112) and the sensor carrier (4) is ring-shaped and is arranged in this recess (12) around the outlet end (112).

10. Firefighting nozzle according to claim 1, characterized in that the channel (11) has an inlet end (111) for extinguishing agent on the rear side of the nozzle body (1) and an outlet end (112) for the extinguishing agent on the front side of the nozzle body (1), the channel (11) has two areas with different diameters, namely a narrower area (113) on the side of the inlet end (111) and a wider area (114) on the side of the outlet end (112), wherein the closure (2) is completely or partially accommodated in the wider area (114) of the channel (11).

11. Sensor carrier (4) comprising a support body (41) provided with at least one sensor (42), with a signal transmitter (44) and with a mechanical support connection (43) for anchoring the support body (41) to a fire-fighting nozzle, wherein the sensor (42) is connected to the signal transmitter (44).

12. Sensor carrier (4) according to claim 11,
characterized in that
the signal transmitter (44) is an electrical support connection (44) suitable for establishing an electrical connection between the sensor (42) and the fire-fighting nozzle.

13. Sensor carrier (4) according to claim 11,
characterized in that
the sensor carrier (4) is ring-shaped.

14. Firefighting system comprising at least one firefighting nozzle according to claim 2 and a control system,
wherein the control system is connected to the signal transmitter (44) of the sensor carrier (4) in such a way that it can receive information from the sensor carrier (4),
wherein the control system is connected to the firefighting nozzle in such a way that it can activate the firefighting nozzle to extinguish a fire, and
wherein the control system is programmed in such a way that it only activates the firefighting nozzle to extinguish the fire when two or more sensors (42) report a fire and/or manual activation is carried out by a fire brigade.
